(19) United States
(12) Patent Application Publication
(10) Pub. No.: US 2010/0245590 A1
(43) Pub. Date: Sep. 30, 2010

(54) CAMERA SENSOR SYSTEM SELF-CALIBRATION

(76) Inventors: Robert P. Cazier, Fort Collins, CO (US); Jason Yost, Windsor, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/743,403

(22) PCT Filed: Nov. 23, 2007
(86) PCT No.: PCT/US07/85469

§ 371 Date: May 18, 2010

(51) Int. Cl. H04N 17/06

(52) U.S. Cl. 348/175; 348/E17.002

(57) ABSTRACT

Systems and methods for camera sensor system self-calibration are disclosed. In an exemplary embodiment, a method may include exposing a camera sensor system to a known output from a camera display. The method may also include determining a calibration value by comparing image signals from the camera sensor system to expected values based on the known output from the camera display. The method may also include storing a calibration value in memory for retrieval during camera use.

### BACKGROUND

Digital cameras include at least one lens and at least one camera sensor, such as, e.g., a charge coupled device or “CCD” or complementary metal oxide semiconductor (CMOS) sensor. The digital camera sensor includes a plurality of photosensitive cells, each of which builds-up or accumulates an electrical charge in response to exposure to light. The accumulated electrical charge for any given pixel is proportional to the intensity and duration of the light exposure, and is used to generate digital photographs.

Camera sensor pixels may respond differently to light. For example, some pixels may output a “darker” value while other pixels output a “brighter” value for an image. However it is desirable that each pixel respond relatively uniformly during use, and in such a manner so as to provide the desired overall level of “brightness” in the picture.

The sensor system (i.e., the camera sensor and/or lens) may be calibrated during manufacture using dedicated calibration hardware and software. However, this adds an additional step to the manufacturing process, increasing production time and costs. In addition, this calibration hardware and software is not generally available, so if the calibration drifts over time the user has no way of recalibrating the sensor system.

### BRIEF DESCRIPTION OF THE DRAWINGS

FIGS. 1a-b are component diagrams of an exemplary camera system which may implement camera sensor self-calibration, wherein (a) shows the camera sensor system focused on a scene being photographed and (b) shows the display positioned adjacent the camera sensor system for self-calibration.

FIG. 2 is a high-level diagram of an exemplary camera sensor system which may be self-calibrated.

FIGS. 3a-b are high-level diagrams of an exemplary camera sensor illustrating pixel data which may be used for camera self-calibration, wherein (a) is prior to self-calibration, and (b) is after self-calibration.

FIGS. 4a-b high-level diagrams of an exemplary image obtained by the same camera sensor system (a) prior to self-calibration, and (b) after self-calibration.

FIG. 5 is a flowchart illustrating exemplary operations which may be implemented for camera sensor system self-calibration.

### DETAILED DESCRIPTION

Systems and methods are disclosed herein for camera sensor system self-calibration. Self-calibration may be implemented by the user to provide a substantially uniform output and overall desired level of brightness for the user's photographs. Self-calibration may use display screen for the camera itself

In an exemplary embodiment, the camera sensor system may be included as part of a camera phone. The camera phone may also include a display screen which can be positioned over the camera sensor system. For example, the camera phone may be a so-called “clam-shell” design wherein the display screen closes over the keypad. According to this design, the camera sensor system may be positioned on the same side of the keypad so that when the display screen is closed over the keypad, the camera sensor system can receive light output by the display screen. In an alternate design, the camera sensor system may be positioned on the opposite side of the keypad and the display screen may be rotated and flipped to cover the camera sensor system so that the camera sensor system can receive light output by the display screen. In either case, the light output by the display screen may be used to self-calibrate the camera sensor system as described in more detail below.

Before continuing, it is noted that camera phones and digital cameras can be readily equipped with a “clam-shell” or other suitable design to position the camera sensor system directly adjacent the display screen based on the current state of the art. Therefore, further description for implementing this feature is not deemed necessary herein.

Although reference is made herein to camera phones for purposes of illustration, it is noted that the systems and methods for self-calibrating camera sensor systems may be implemented with any of a wide range of digital still-photo and/or video cameras, now known or that may be later developed. In yet other embodiments, self-calibration may also be used for the sensors of other imaging devices (e.g., scanners, medical imaging, etc.).

### Exemplary Systems

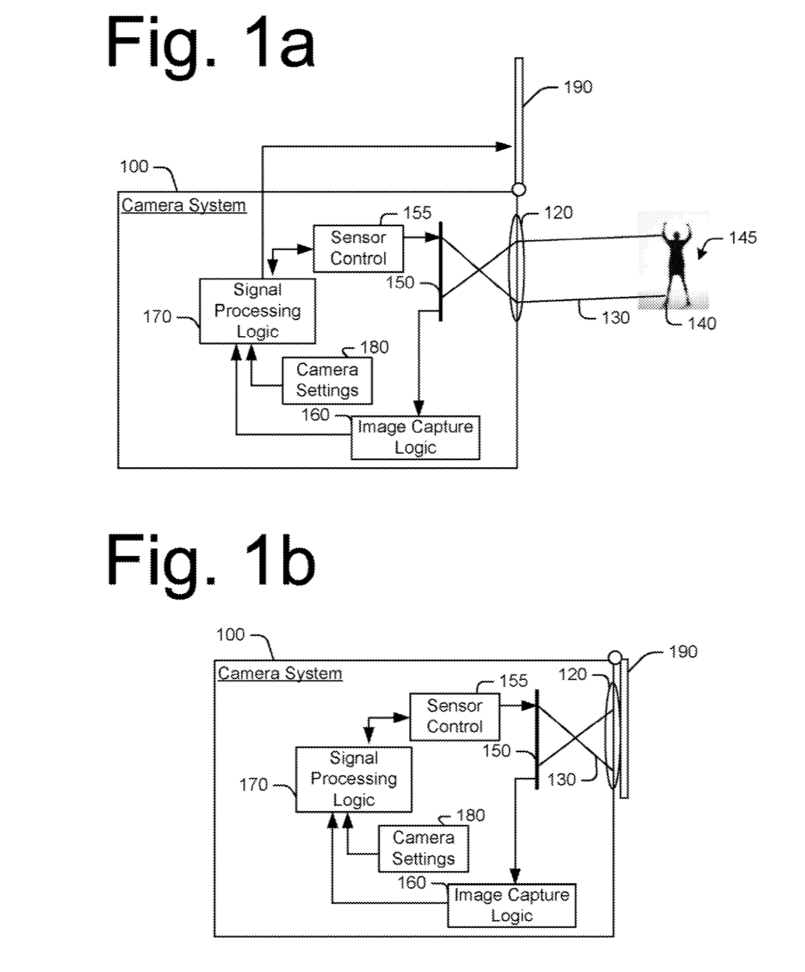

FIGS. 1a-b are component diagrams of an exemplary camera system which may implement camera sensor system self-calibration, wherein FIG. 1a shows the camera sensor system focused on a scene being photographed and FIG. 1b shows the display positioned adjacent the camera sensor system for self-calibration. Exemplary camera system 100 may include a lens 120 positioned in the camera system 100 to focus light 130 reflected from one or more objects 140 in a scene 145 onto a camera sensor 150. Exemplary lens 120 may be any suitable lens which focuses light 130 reflected from the scene 145 onto camera sensor 150.

It is noted that the term “camera sensor system” as used herein refers to the camera lens 120 and/or camera sensor 150. For example, both the camera lens and camera sensor may need to be calibrated as a pair for various operations such as vignetting.

Camera system 100 may also include image capture logic 160. In digital cameras, the image capture logic 160 reads out the charge build-up from the camera sensor 150. The image capture logic 160 generates image data signals representative of the light 130 captured during exposure to the scene 145. The image data signals may be implemented by the camera for self-calibration as described in more detail below, and for other operations typical in camera systems, e.g., auto-focusing, auto-exposure, pre-flash calculations, image stabilizing, and/or detecting white balance, to name only a few examples.

The camera system 100 may be provided with signal processing logic 170 operatively associated with the image capture logic 160, and optionally, with camera settings 180. The signal processing logic 170 may receive as input image data signals from the image capture logic 160. Signal processing logic 170 may be implemented to perform various calculations or processes on the image data signals, as described in more detail below.

In addition, the signal processing logic 170 may also venerate output for other devices and/or logic in the camera system 100. For example, the signal processing logic 170 may generate control signals for output to sensor control module 155 to adjust the camera sensor 150 based on the self-calibration. Signal processing logic 170 may also receive information from the sensor control 155, e.g., for the self calibration.

In an exemplary embodiment, self-calibration of the camera sensor system uses the camera's own display 190. The display 190 is positioned adjacent the camera sensor system as illustrated in FIG. 1b by closing the display 190 over the camera sensor system, e.g., as described above with reference to the clam-shell design for camera phones. The display 190 outputs a known light signal (e.g., an all white screen, or varying colors as known times). The camera sensor system receives light output by the display 190. Because it is known what the output should be and what the output actually is, the image signals can be processed by the image capture logic 160 and signal processing logic 170 to self-calibrate the camera sensor system.

Although calibration may occur during manufacture, calibration does not need to occur during manufacture, thereby saving the manufacturer time and reducing manufacturing costs. Instead, the user may implement the self-calibration procedure described herein after purchasing the camera. Accordingly, any changes between the time of manufacture and the time the user is going to use the camera do not adversely affect operation of the camera sensor system.

In addition, the camera sensor system may change over time due to any of a wide variety of factors (e.g., use conditions, altitude, temperature, background noise, sensor damage, etc.). Accordingly, the user may self-calibrate the camera sensor system at any time the user perceives a need to re-calibrate using the techniques described herein, instead of being stuck with the initial calibration of the camera sensor system, e.g., when the camera is calibrated by the manufacturer.

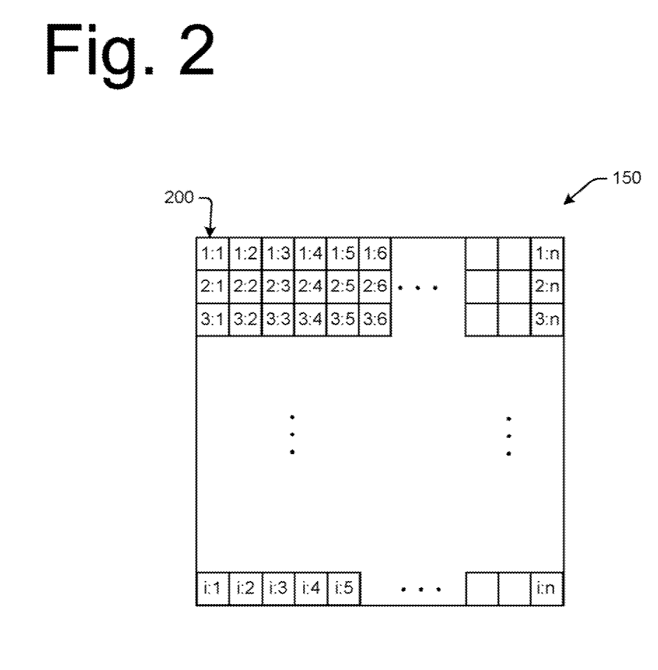

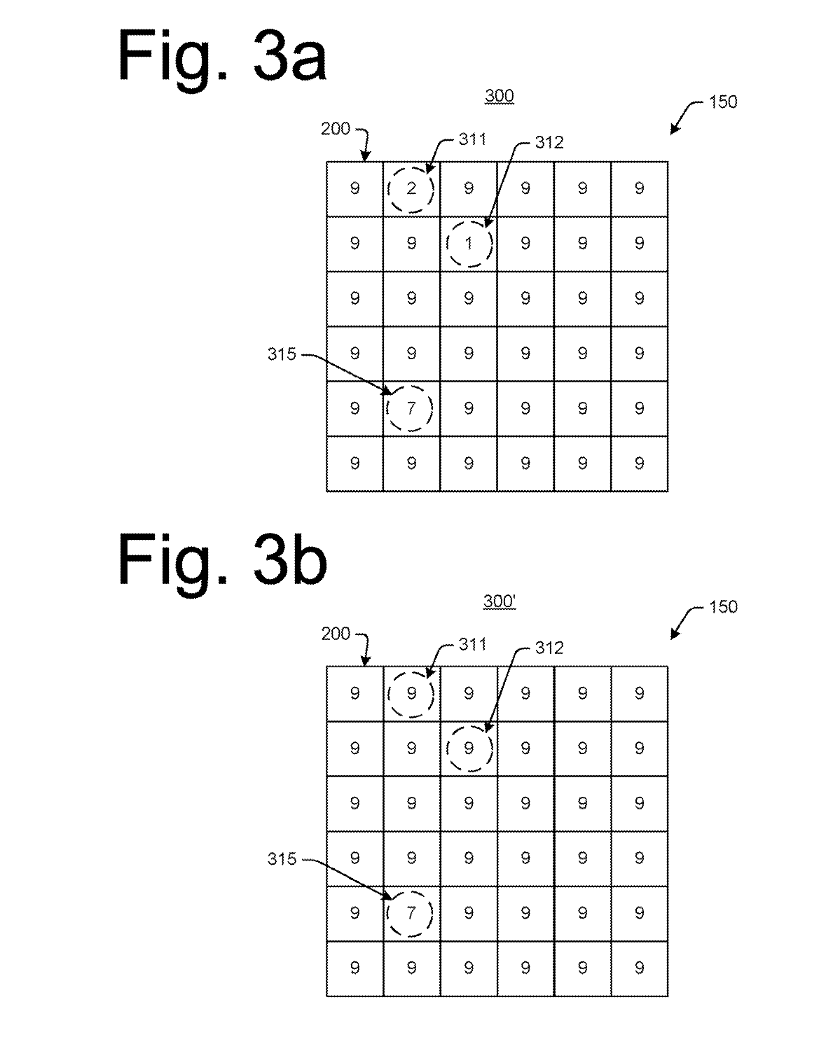

Exemplary embodiments for camera sensor system self-calibration can be better understood with reference to the exemplary camera sensor shown in FIG. 2 and illustrations shown in FIGS. 3a-b and 4a-b.

FIG. 2 is a high-level diagram of an exemplary camera sensor which may be self-calibrated, such as the camera sensor 150 described above for camera system 100 shown in FIGS. 1a-b. For purposes of this illustration, the camera sensor 150 is implemented as an interline CCD. However, the camera sensor 150 is not limited to interline CCDs. For example, the camera sensor 150 may be implemented as a frame transfer CCD, an interlaced CCD, CMOS sensor, or any of a wide range of other camera sensors now known or later developed.

In FIG. 2, photocells 200 are identified according to row:column number. For example, 1:1, 1:2, 1:3, . . . 1:n correspond to columns 1-n in row 1; and 2:1, 2:1, 2:2, 2:3, . . . 1:n correspond to columns 2-n in row 2. Although n columns and i rows of photocells 200 are shown, it is noted that the camera sensor 150 may include any number of photocells 200. The number of photocells 200 may depend on a number of considerations, such as, e.g., image size, image quality, operating speed, cost, etc.

During operation, the active photocells 200 become charged during exposure to light reflected from the scene. This charge accumulation (or “pixel data”) read out after the desired exposure time. In an exemplary embodiment, the camera sensor 150 is exposed to a known light source via the camera lens (e.g., lens 120 in FIGS. 1a-b) from the camera's own display (e.g., display 190 in FIGS. 1a-b), and the corresponding pixel data may be used for self-calibration as explained in more detail with reference to FIGS. 3a-b.

FIGS. 3a-b are high-level diagrams of an exemplary camera sensor, such as the camera sensor 150 described above for camera system 100 shown in FIGS. 1a-b and FIG. 2 In FIGS. 3a-b, the camera sensor is shown illustrating pixel data which may be used for camera self-calibration. Specifically, FIG. 3a shows pixel data received from the camera's display prior to self-calibration, and FIG. 3b shows pixel data for the same camera sensor after self-calibration.

For purposes of simplification, the camera sensor 150 is shown in FIGS. 3a-b having six columns and six rows of active photocells 200. For purposes of this example, the charge accumulation or pixel data 300 and 300′ is shown as numerical values ranging from the value “1” (indicating a low reflected light level or dark areas) to the value “9” (indicating a very bright reflected light), although actual pixel data may range from values of 1 to values of 1000 or more.

During self-calibration, the camera sensor 150 is exposed to a known light source (e.g., output by the camera's own display positioned adjacent the camera sensor). In this example, the known light source is all white. Accordingly, the pixel data 300 includes mostly “9s” (representing the white), with several pixels having darker values such as a value “2” at pixel 311 and a value “1” at pixel 312.

After the desired exposure time, the pixel data 300 may be read out of the active photocells 200 and compared to pixel data expected based on the known light source. In an exemplary embodiment, the comparison may be handled by a comparison engine. The comparison engine may be implemented as part of the processing logic residing in memory and executing on a processor in the camera system.

During the comparison procedure, pixels 311 and 312 are found to have a relatively high pixel value. Accordingly, pixels 311 and 312 may be adjusted to correct values output by these pixels. The correction factor may be stored in memory, e.g., as calibration data for the image sensor.

In an exemplary embodiment, a threshold may be implemented wherein pixels displaying substantially the expected value are not corrected. For example, pixel 315 recorded a pixel value of “7”. Because this value is considered to be “close enough” (i.e., the threshold is satisfied), no correction is needed in order to maintain fairly uniform output from all of the pixel sensors.

It is noted that although the calibration procedure described above with reference to FIGS. 3a-b is illustrated using a constant white light source, the known light source is not limited to any particular color. For example, the known light source may be a different color. Or for example, the known light source may be variable, wherein multiple different colors are displayed (so-called “spectral” calibration) for predetermined times during the self-calibration procedure. In an event, the processing logic may compare the actual pixel values recorded by the image sensor to the expected pixel values at the corresponding time(s) in order to obtain the calibration data that can be applied as compensation factors during actual use of the camera.

It is also noted that other, more complex, self-calibration algorithms may be implemented. For example, shading and vignetting calibration may be implemented, wherein the shading and vignetting correction curves are extracted and stored in the camera's memory. Selection of a specific self-calibration algorithm will depend on a variety of design considerations, such as, e.g., time allotted for the calibration, desired image quality, camera sensor system size/complexity/quality, etc.

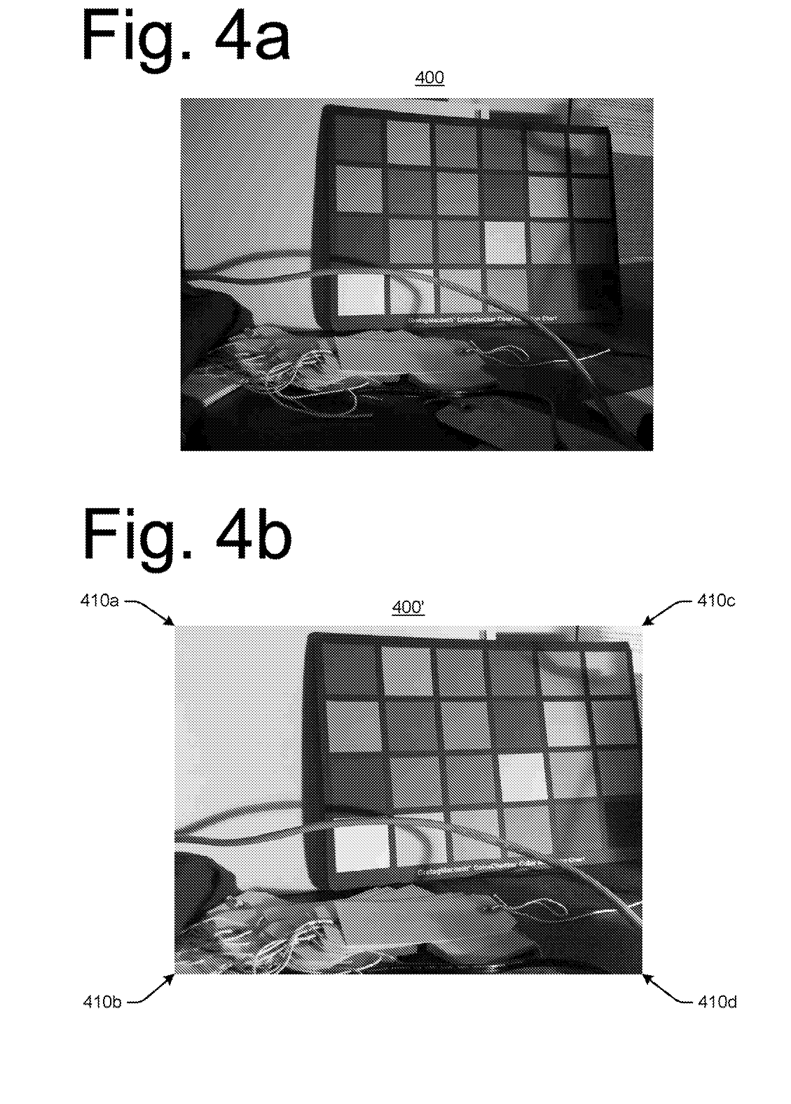

FIGS. 4a-b are high-level diagrams of an exemplary image obtained by the same camera sensor system. The image 400 shown in FIG. 4a is prior to the user applying the self-calibration procedure, and appears generally dark and uneven. The image 400′ shown in FIG. 4b is an image of the same scene as image 400, but after the user has applied the self-calibration procedure. It is readily apparent from a comparison of the two images, particularly at the edges 410a-d, that self-calibration results in more uniform, enhanced (e.g., “brighter”) picture quality.

Before continuing, it is noted that the systems and illustrations described above are merely exemplary and not intended to be limiting. Additional user interface features may be implemented to facilitate ease-of-use of the self-calibration procedure by the user. These features may include instructions for the user to position the camera display adjacent the camera sensor system (e.g., by closing the clam-shell on a camera phone), then a notification for the user when self-calibration is complete. Other features may include a notification for the user when the self-calibration is interrupted or otherwise needs to be repeated. These, and other features, may be implemented using visual and/or audio signals for the user.

These and other features and/or modifications may also be implemented, as will be readily appreciated by those having ordinary skill in the art after becoming familiar with the teachings herein.

### Exemplary Operations

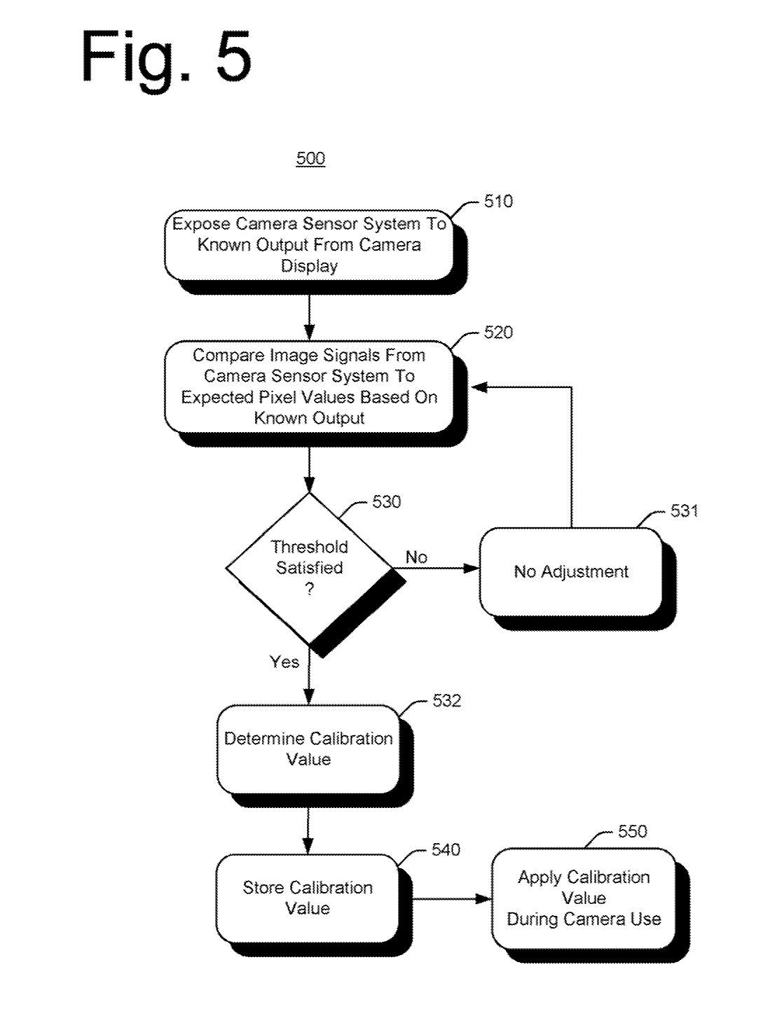

FIG. 5 is a flowchart illustrating exemplary operations which may be implemented for camera sensor system self-calibration. Operations 500 may be embodied as logic instructions on one or more computer-readable medium. When executed on a processor, the logic instructions cause a general purpose computing device to be programmed as a special-purpose machine that implements the described operations in an exemplary implementation, the components and connections depicted in the figures may be used.

In operation 510, a camera sensor system is exposed to a known output a known light source for a known duration) from the camera's own display to obtain image signals. In an exemplary embodiment, the camera's display may be positioned directly adjacent the camera sensor system, e.g., by closing the display over the camera sensor system in a clam-shell camera phone design.

In operation 520, the image signals are compared to expected pixel values based on the known output of the camera's display. In operation 530, a determination is made whether to adjust a pixel during the calibration procedure. In an exemplary embodiment, a threshold value may be used for the comparison. Pixels satisfying the threshold may not be adjusted, as indicated by operation 531. However, pixels which do not satisfy the threshold may be adjusted, as indicated by operation 532. Using a threshold may be used to speed up the calibration procedure. Other embodiments may also be implemented to speed up the calibration. For example, pixels may be compared and adjusted as a group rather than as individual pixels.

In operation 540, calibration values are stored in the camera's memory. For example, if a pixel read lower than expected based on the known output of the camera's display, the pixel location and a correction factor (e.g., “increase X %” to at least meet the threshold) may be stored in a data structure in the camera's memory for later retrieval. In operation 550, the calibration values are applied to the corresponding pixels in an image captured by the camera sensor system during camera use.

The operations shown and described herein are provided to illustrate exemplary implementations for camera sensor system self-calibration. For example, the operations may be continuous, wherein the image signals are analyzed and a calibration value are applied to one or more pixels while the camera sensor system is being exposed to output from the camera display for a real-time feedback loop.

In addition, the operations are not limited to the ordering shown. Still other operations may also be implemented as will be readily apparent to those having ordinary skill in the art after becoming familiar with the teachings herein.

It is noted that the exemplary embodiments shown and described are provided for purposes of illustration and are not intended to be limiting. Still other embodiments are also contemplated for camera sensor system self-calibration.

1. A method for camera sensor system self-calibration, comprising:
exposing a camera sensor system to a known output from a camera display;
determining a calibration value by comparing image signals from the camera sensor system to expected values based on the known output from the camera display; and
storing a calibration value in memory for retrieval during camera use.

2. The method of claim 1, wherein exposing and determining are part of a real-time feedback loop.

3. The method of claim 1, wherein a pixel in the camera sensor system is only corrected if a threshold is not satisfied to speed up the self-calibration.

4. The method of claim 1, wherein a calibration value is stored for a group of pixels in the camera sensor system to speed up the self-calibration.

5. The method of claim 1, further comprising notifying the user after self-calibration is complete.

6. The method of claim 1, further comprising notifying the user if self-calibration needs repeating.

7. The method of claim 1, further comprising the user activating the self-calibration at any time.

8. The method of claim 1, wherein self-calibration enables the sensor system to achieve more uniform image quality than without the self-calibration.

9. A camera system comprising:
a camera display generating a known output;
a self-calibrating camera sensor system attached to the camera display, the self-calibrating camera sensor system generating image signals corresponding to the known output when positioned adjacent the camera display;
processing logic executing to compare the image signals generated by the self-calibrating camera sensor system to the known output from the camera display, the processing logic determining a calibration value for the self-calibrating camera sensor system based on the comparison; and
a sensor control for applying the calibration value to the self-calibrating camera sensor system during use.

10. The camera system of claim 9, wherein the sensor is a digital camera sensor system.

11. The camera system of claim 9, wherein the calibration value corrects pixel values for sensor defects.

12. The camera system of claim 9, further comprising a data structure onboard the camera for storing the calibration value for later retrieval during camera use.

13. The camera system of claim 9, further comprising a clam-shell design housing for the camera sensor system and the camera display, wherein the camera sensor system is automatically positioned directly adjacent the camera display when the clam-shell design housing is closed.

14. The camera system of claim 9, wherein the known output is a white light source displayed for a predetermined time.

15. The camera system of claim 9, wherein the known output is a variable light source, in which each color of the variable light source is displayed for a predetermined time.

16. The camera system of claim 9, wherein the processing logic uses shading and vignetting correction curves for determining a calibration value.

17. The camera system of claim 9, further comprising a real-time feedback loop for analyzing image signals and updating the camera sensor system during calibration.

18. The camera system of claim 9, wherein the calibration value is applied only if a threshold is not satisfied.

19. A system for image sensor self-calibration comprising:
means for generating a known output;
means for generating image signals corresponding to the known output from the means for generating the known output;
means for comparing the image signals to the known output;
means for determining a calibration value based on the comparison; and
means for applying the calibration value to the means for generating image signals during use.

20. The system of claim 19, further comprising means for positioning the means for generating image signals directly adjacent the means for generating, the known output when each is housed together.
